(19) United States
(12) Patent Application Publication
(10) Pub. No.: US 2026/0240709 A1
(43) Pub. Date: Aug. 20, 2026

(54) BODY STRETCHING ASSISTANT

(71) Applicant: Michael Mead, Ellicottville, NY (US)

(72) Inventor: Michael Mead, Ellicottville, NY (US)

(21) Appl. No.: 19/055,557

(22) Filed: Feb. 18, 2025

(51) Int. Cl. A61H 1/02; B65H 75/40; B65H 75/44

(52) U.S. Cl. CPC A61H 1/02; B65H 75/406; B65H 75/4486; A61H 2201/1215; A61H 2201/1463; A61H 2201/1635; A61H 2201/1673

(57) ABSTRACT

A body stretching assistant, including a cord, a main body to house the cord therein, including a handle to protrude from a surface of the main body, and a cord aperture disposed on the surface of the main body to allow the cord to be extracted from the main body through the cord aperture, and a cord receiving member disposed on the surface of the main body to allow a first end of the cord to be attached to the cord receiving member, a cord wrapping wheel configured to attach to a second end of the cord, and a motor disposed within the main body and coupled to the cord wrapping wheel such that the motor is configured to cause the cord wrapping wheel to selectively rotate in a first direction or a second direction in response to the motor being activated.

### BACKGROUND

### Field

The present general inventive concept relates generally to physical therapy, and particularly, to a body stretching assistant.

### Description of the Related Art

Assisted stretching is a therapeutic treatment offered by rehabilitation centers, physical therapists, and/or doctors for recovering athletes, injured individuals, and/or any other persons experiencing muscle discomfort. Although incredibly beneficial, the treatment is quite expensive and not one that is commonly sought by many. Moreover, to ensure the treatment is actually beneficial, a person seeking relief must get assisted stretching consistently, which not only warrants regular doctor and/or rehab center visits, but also increases expenditure.

While people can perform various type of stretches individually without external assistance, people are rarely able to push themselves in ways that would achieve results. A third party could oftentimes help a person receive better stretching results, but a third party is not always available. Thus, the person seeking relief from pain will continue to feel pain and/or discomfort for longer periods of time than could be achieved if proper stretching techniques were achieved.

Therefore, there is a need for a body stretching device that facilitates stretching by a user without assistance from a third party.

### SUMMARY

The present general inventive concept provides a body stretching assistant.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a body stretching assistant, including a body stretching assistant, including a cord, a main body to house at least a portion of the cord therein, the main body including a handle to protrude from a surface of the main body at a first end of the main body to allow a user to grab and hold onto the main body, and a cord aperture disposed on the surface of the main body at a second end of the main body opposite from the first end of the main body to allow portions of the cord to be extracted from the main body through the cord aperture, and a cord receiving member disposed on the surface of the main body and configured to allow a first end of the cord to be attached to the cord receiving member, a spindle disposed within the main body, a cord wrapping wheel rotatably disposed on the spindle and configured to attach to a second end of the cord such that a portion of the cord disposed within the main body is wrapped around the cord wrapping wheel, and such that the cord wrapping wheel is rotatable in a first direction to allow portions of the cord to be extracted from the main body through the cord aperture, and such that the cord wrapping wheel is rotatable in a second direction to allow portions of the cord to enter the main body through the cord aperture and wrap around the cord wrapping wheel, and a motor disposed within the main body and coupled to the cord wrapping wheel such that the motor is configured to cause the cord wrapping wheel to selectively rotate in a first direction or a second direction in response to the motor being activated, such that the rotation of the motor is transferred to the cord wrapping wheel to cause the cord wrapping wheel to rotate in the first direction or the second direction.

The body stretching assistant may further include a motor control unit electrically connected to the motor to control the rotational direction of the motor, the motor control unit including a bi-directional switch disposed on the handle and configured to be pressable at left side of the bi-directional switch to activate the motor to rotate in the first direction such that the cord wrapping wheel also rotates in the first direction to extract portions of the cord from the main body through the cord aperture, and configured to be pressable at a right side of the bi-directional switch to activate the motor to rotate in the second direction such that the cord wrapping wheel also rotates in the second direction to retract portions of the cord back into the main body through the cord aperture such that the retracted portions of the cord wrap around the cord wrapping wheel, and a speed regulating knob turnably disposed on the handle and configured to cause a speed of rotation of the motor to increase in response to the speed regulating knob being turned in a first direction, and configured to cause the speed of rotation of the motor to decrease in response to the speed regulating knob being turned in a second direction.

The body stretching assistant may further include a pulley to attach to an outside object or surface and configured to allow portions of the cord disposed outside the main body to be threaded therethrough.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top, left, front perspective view of a body stretching assistant, according to an exemplary embodiment of the present general inventive concept;

FIG. 2 illustrates a front perspective view of the body stretching assistant of FIG. 1, according to an exemplary embodiment of the present general inventive concept;

FIG. 3 illustrates a zoomed in top, left, rear perspective view of the body stretching assistant of FIG. 1, according to an exemplary embodiment of the present general inventive concept; and

FIG. 4 illustrates a side perspective view of a body stretching assistant, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Body Stretching Assistant 100

Main Body 110

Handle 111

Cord Aperture 112

Cord Receiving Member 113

Cord 120

Cord to Main Body Securing Hook 121

Cord Wrapping Wheel 130

Spindle 131

Motor 140

Battery 150

Charging Port 151

Battery to Motor Wiring 152

Motor Control Unit 160

Bi-Directional Switch 161

Speed Regulating Knob 162

Motor Control Unit Wiring 163

Pulley 170

Pulley Block 171

Pulley Sheave 172

Pulley Attaching Assembly 180

Carabiner 181

Swiveling Connector 182

Strap 183

Body Stretching Assistant 200

Main Body 210

Handle 211

Cord Aperture 212

Cord Receiving Member 213

Cord 220

Cord to Main Body Securing Hook 221

Cord Wrapping Wheel 230

Spindle 231

Motor 240

Battery 250

Charging Port 251

Motor Control Unit 260

Bi-Directional Switch 261

Speed Regulating Knob 262

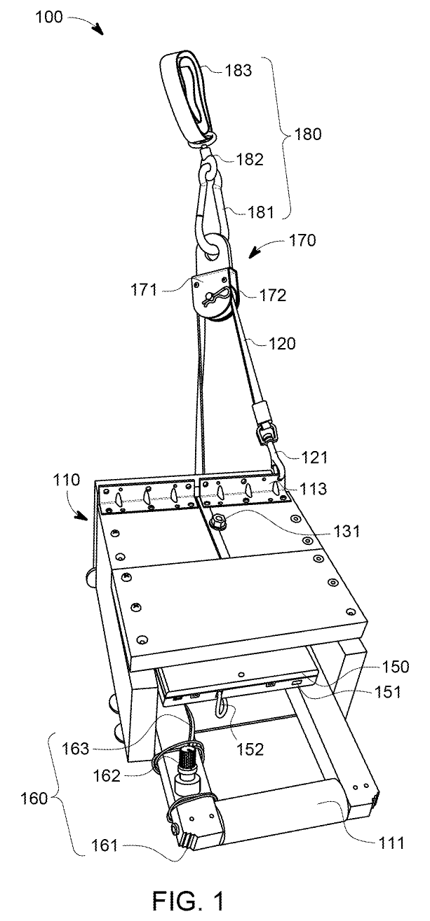

FIG. 1 illustrates a top, left, front perspective view of a body stretching assistant 100, according to an exemplary embodiment of the present general inventive concept.

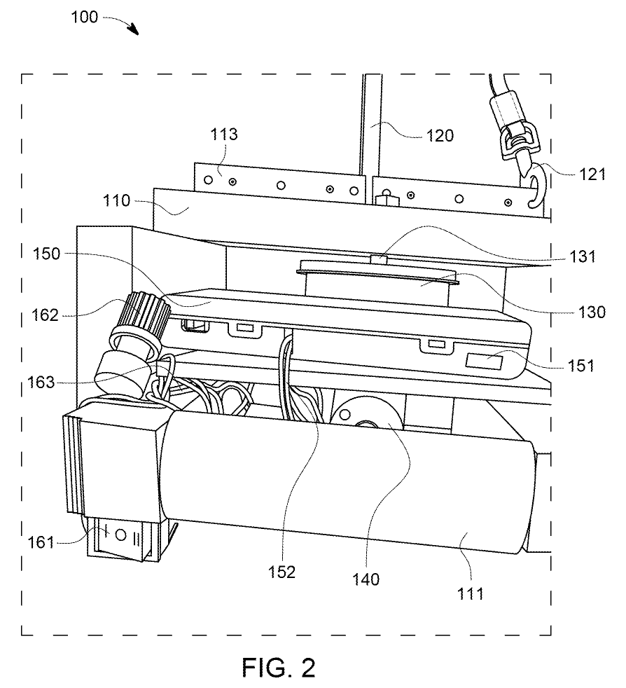

FIG. 2 illustrates a front perspective view of the body stretching assistant 100 of FIG. 1, according to an exemplary embodiment of the present general inventive concept.

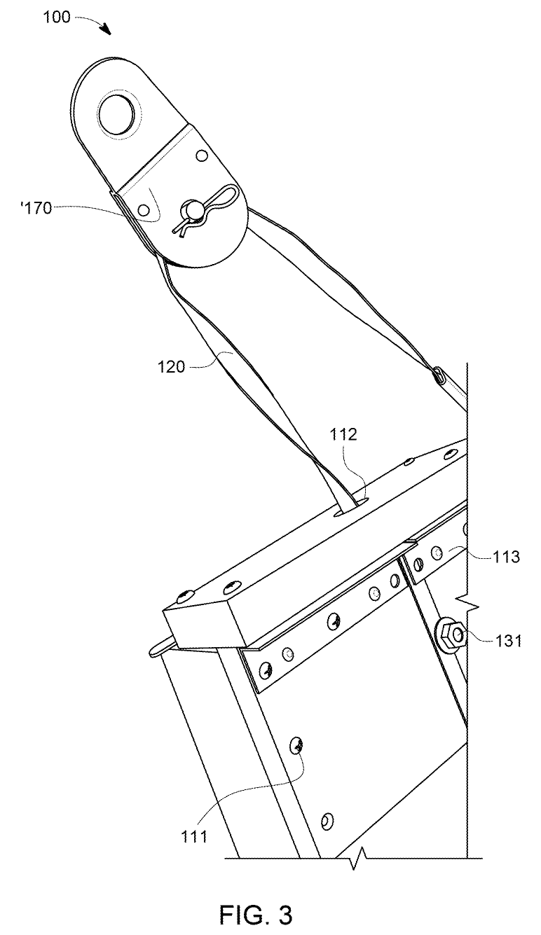

FIG. 3 illustrates a zoomed in top, left, rear perspective view of the body stretching assistant 100 of FIG. 1, according to an exemplary embodiment of the present general inventive concept.

The body stretching assistant 100 of FIG. 1, and all components therein and/or connected thereto, may be constructed from at least one of metal, plastic, stone, ceramics, wood, silicone, liquid, gel, polyester, cotton, wool, insulation material, glass, paper, cloth, circuitry, leather, memory foam, latex, and rubber, etc., but is not limited thereto, and can be constructed from any material known to one of ordinary skill in the art.

Referring to FIGS. 1 through 3, the body stretching assistant 100 may include a main body 110, a cord 120, a cord wrapping wheel 130, a motor 140, a battery 150, a motor control unit 160, a pulley 170, and a pulley attaching assembly 180, but is not limited thereto.

Referring to FIG. 1, the main body 110 is illustrated to have a shape similar to an old-time tape recorder with a handle, but the main body 110 is not limited to the shape depicted in FIG. 1, and may have any shape known to one of ordinary skill in the art.

The main body 110 may include a handle 111, a cord aperture 112, and a cord receiving member 113, but is not limited thereto.

The handle 111 may be any type of handle that protrudes outwardly from the main body 110, and that which may be configured to allow a user to hold onto the body stretching assistant 100. As illustrated in FIGS. 1 and 2, the handle 111 may protrude from a front portion of the main body 110, but is not limited thereto.

The cord aperture 112 may be an aperture (e.g., hole) disposed at a surface of the main body 110 that allows the cord 120 to be threaded therethrough.

The cord receiving member 113 may be disposed on a surface of the main body 110, and may be configured to receive the cord 120 thereon. Specifically, the cord 120 may be attached to the cord receiving member 113. The cord receiving member 113 may be a loop, hook, plate, or any other type of member that allows the cord 120 to be attached thereto.

The cord 120 may be any type of cord known to one of ordinary skill in the art, but preferably, should be a cord that is durable enough to withstand a significant amount of weight and/or pressure applied thereto.

The cord 120 may include a cord to main body securing hook 121 attached to a first end thereof. The cord to main body securing hook 121 may attach to (e.g., couple to) the cord receiving member 113 of the main body 110.

The cord wrapping wheel 130 may be disposed within the main body 110, and may be rotatably disposed on a spindle 131 that is also disposed within the main body 110. The cord 120 may have a second end attached to the cord wrapping wheel 130, such that the cord 120 may be wrapped around the cord wrapping wheel 130 as the cord wrapping wheel 130 rotates about the spindle 131.

The motor 140 may be disposed within the main body 110, and may be attached to (e.g., coupled to) the cord wrapping wheel 130, such that the motor 140 may be configured to cause the cord wrapping wheel 130 to rotate when the motor 140 is activated. Specifically, the motor 140 may rotate in a clockwise direction or a counter-clockwise direction, and thus transfer the rotation of the motor 140 to the cord wrapping wheel 130.

The battery 150 may be any type of battery known to one of ordinary skill in the art, and preferably, may be a rechargeable battery.

A charging port 151 may be disposed on and/or connected to the battery 150 (and may also be accessible directly from an outer surface of the main body 110), and may be any type of port known to one of ordinary skill in the art that allows for the battery 150 to be charged, including, but not limited to, a USB port, a mini USB port, a micro USB port, a USB-C port, a lightning port, etc.

The battery to motor wiring 152 may electrically connect the battery 150 to the motor 140, and may allow the battery 150 to supply power to the motor 140.

The motor control unit 160 may include a plurality of components, including a bi-directional switch 161, a speed regulating knob 162, and motor control unit wiring 163, but is not limited thereto.

The bi-directional switch 161 may be electrically connected to the speed regulating knob 162 via the motor control unit wiring 163, but this is not required.

The motor control unit 160 (i.e., bi-directional switch 161 and the speed regulating knob 162) may be electrically connected to at least one of the motor 140 and the battery 150 via the motor control unit wiring 163, such that the bi-directional switch 161 and/or the speed regulating knob 162 may control rotational direction and/or rotational speed of the motor 140.

Specifically, the bi-directional switch 161 may be pressed at a right side of the bi-directional switch 161 to activate the motor 140 to turn (i.e., rotate) in a clockwise direction, thereby causing the cord wrapping wheel 130 to also rotate in a clockwise direction such that the cord 120 retracts and wraps around the cord wrapping wheel 130 (i.e., a portion of the cord 120 outside the main body 110 becomes shorter).

Alternatively, the bi-directional switch 161 may be pressed at a left side of the bi-directional switch 161 to activate the motor 140 to turn (i.e., rotate) in a counter-clockwise direction, thereby causing the cord wrapping wheel 130 to also rotate in a counter-clockwise direction such that the cord 120 unwraps from the cord wrapping wheel 130 (i.e., a portion of the cord 120 outside the main body 110 becomes longer).

The pulley 170 may be any type of pulley known to one of ordinary skill in the art, and may include a pulley block 171, and a pulley sheave 172 rotatably attached to the pulley block 171, but is not limited thereto.

The pulley block 171 may open to allow the cord 120 to be inserted therein such that the pulley sheave 172 is able to receive the cord 120 thereon, in order to cause the cord 120 to take advantage of the pulley mechanism and action of the pulley 170.

The pulley attaching assembly 180 may include a carabiner 181, a swiveling connector 182, and a strap 183, but is not limited thereto.

The pulley attaching assembly 180 may be configured to attach to and/or connect to an outside object and/or surface, such as a door jamb, door handle, or closed door, for example. As such, the pulley attaching assembly 180 may be configured to allow the pulley 170 to be attached to the outside object and/or surface.

The carabiner 181 may attach to at least a portion of the pulley 170, such as the pulley block 171, at a first end of the carabiner 181, and a second end of the carabiner 181 may be attached to the swiveling connector 182 at a first end of the swiveling connector 182. A second end of the swiveling connector 182 may connect to the strap 183. The strap 183 may wrap around an object, such as a door knob or pole.

The following includes a descriptive example of how a user may utilize the body stretching assistant 100 of FIG. 1 to perform a stretch.

The body stretching assistant 100 may be configured to allow a user to hold the body stretching assistant 100 with two hands (i.e., while the user is sitting on the ground in a split-stretch, for example), and the cord 120 may wrap around an external object, such as a door handle (but is not limited thereto, and may wrap around any type of secure external object), such that the cord to main body securing hook 121 attaches to the cord receiving member 113 of the main body 110 to allow a user to experience a stretch when the motor 140 is activated via the bi-directional switch 161, which causes the cord 120 to wind around the cord wrapping wheel 130.

Therefore, the body stretching assistant 100 may facilitate stretching by the user without assistance from another person. Also, the body stretching assistant 100 may improve recovery for the user without requiring significant time and/or cost.

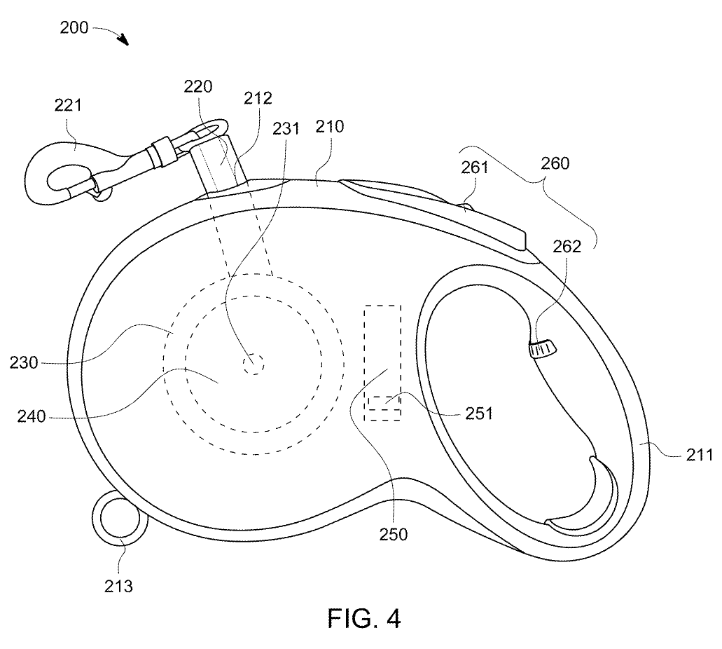

FIG. 4 illustrates a side perspective view of a body stretching assistant 200, according to another exemplary embodiment of the present general inventive concept.

The body stretching assistant 200 of FIG. 4, and all components therein and/or connected thereto, may be constructed from at least one of metal, plastic, stone, ceramics, wood, silicone, liquid, gel, polyester, cotton, wool, insulation material, glass, paper, cloth, circuitry, leather, memory foam, latex, and rubber, etc., but is not limited thereto, and can be constructed from any material known to one of ordinary skill in the art.

Referring to FIG. 4, the body stretching assistant 200 may include a main body 210, a cord 220, a cord wrapping wheel 230, a motor 240, a battery 250, and a motor control unit 260, but is not limited thereto.

Also, it is noteworthy that the pulley 170 and the pulley attaching assembly 180 of the embodiment illustrated in FIG. 1 may be utilized with the body stretching assistant 200 in the embodiment of FIG. 4, in a manner similar to the body stretching assistant 100 in the embodiment of FIG. 1.

Referring to FIG. 4, the main body 210 is illustrated to have a thin and aerodynamic shape, but the main body 210 is not limited to the shape depicted in FIG. 4, and may have any shape known to one of ordinary skill in the art.

The main body 210 may include a handle 211, a cord aperture 212, and a cord receiving member 213, but is not limited thereto.

The handle 211 may be any type of handle that protrudes outwardly from the main body 210, and that which may be configured to allow a user to hold onto the body stretching assistant 200.

The cord aperture 212 may be an aperture (e.g., hole) disposed at a surface of the main body 210 that allows the cord 220 to be threaded therethrough.

The cord receiving member 213 may be disposed on a surface of the main body 210, and may be configured to receive the cord 220 thereon. Specifically, the cord 220 be attach to the cord receiving member 213. The cord receiving member 213 may be a loop, hook, plate, or any other type of member that allows the cord 220 to be attached thereto.

The cord 220 may be any type of cord known to one of ordinary skill in the art, but preferably, should be a cord that is durable enough to withstand a significant amount of weight and/or pressure applied thereto.

The cord 220 may include a cord to main body securing hook 221 attached to a first end thereof. The cord to main body securing hook 221 may attach to (e.g., couple to) the cord receiving member 213 of the main body 210.

The cord wrapping wheel 230 may be disposed within the main body 210, and may be rotatably disposed on a spindle 231 that is also disposed within the main body 210. The cord 220 may have a second end attached to the cord wrapping wheel 230, such that the cord 220 may be wrapped around the cord wrapping wheel 230 as the cord wrapping wheel 230 rotates about the spindle 231.

The motor 240 may be disposed within the main body 210, and may be attached to (e.g., coupled to) the cord wrapping wheel 230, such that the motor 240 may be configured to cause the cord wrapping wheel 230 to rotate when the motor 240 is activated. Specifically, the motor 240 may rotate in a clockwise direction or a counter-clockwise direction, and thus transfer the rotation of the motor 240 to the cord wrapping wheel 130.

The battery 250 may be any type of battery known to one of ordinary skill in the art, and preferably, may be a rechargeable battery.

A charging port 251 may be disposed on and/or connected to the battery 250 (and may also be accessible directly from an outer surface of the main body 210), and may be any type of port known to one of ordinary skill in the art that allows for the battery 250 to be charged, including, but not limited to, a USB port, a mini USB port, a micro USB port, a USB-C port, a lightning port, etc.

The battery 250 may be electrically connected to the motor 240, thereby allowing the battery 250 to supply power to the motor 240.

The motor control unit 260 may include a plurality of components, including a bi-directional switch 261, and a speed regulating knob 262, but is not limited thereto.

The bi-directional switch 261 may be electrically connected to the speed regulating knob 262, but this is not required.

The motor control unit 260 (i.e., bi-directional switch 261 and the speed regulating knob 262) may be electrically connected to at least one of the motor 240 and the battery 250, such that the bi-directional switch 261 and/or the speed regulating knob 262 may control rotational direction and/or rotational speed of the motor 240.

Specifically, the bi-directional switch 261 may be pressed at a right side of the bi-directional switch 261 to activate the motor 240 to turn (i.e., rotate) in a clockwise direction, thereby causing the cord wrapping wheel 230 to also rotate in a clockwise direction such that the cord 220 retracts and wraps around the cord wrapping wheel 230 (i.e., a portion of the cord 220 outside the main body 210 becomes shorter).

Alternatively, the bi-directional switch 261 may be pressed at a left side of the bi-directional switch 261 to activate the motor 240 to turn (i.e., rotate) in a counter-clockwise direction, thereby causing the cord wrapping wheel 230 to also rotate in a counter-clockwise direction such that the cord 220 unwraps from the cord wrapping wheel 230 (i.e., a portion of the cord 220 outside the main body 210 becomes longer).

The following includes a descriptive example of how a user may utilize the body stretching assistant 200 of FIG. 4 to perform a stretch.

The body stretching assistant 200 may be configured to allow a user to hold the body stretching assistant 200 with one hand (i.e., while the user is sitting on the ground in a split-stretch, for example), and the cord 220 may wrap around an external object, such as a door handle (but is not limited thereto, and may wrap around any type of secure external object), such that the cord to main body securing hook 221 attaches to the cord receiving member 213 of the main body 210 to allow a user to experience a stretch when the motor 240 is activated via the bi-directional switch 261, which causes the cord 220 to wind around the cord wrapping wheel 230.

Therefore, the body stretching assistant 200 may facilitate stretching by the user without assistance from another person. Also, the body stretching assistant 200 may improve recovery for the user without requiring significant time and/or cost.

The present general inventive concept may include a body stretching assistant 100, including a cord 120, a main body 110 to house at least a portion of the cord 120 therein, the main body 110 including a handle 111 to protrude from a surface of the main body 110 at a first end of the main body 110 to allow a user to grab and hold onto the main body 110, and a cord aperture 112 disposed on the surface of the main body 110 at a second end of the main body 110 opposite from the first end of the main body 110 to allow portions of the cord 120 to be extracted from the main body 110 through the cord aperture 112, and a cord receiving member 113 disposed on the surface of the main body 110 and configured to allow a first end of the cord 120 to be attached to the cord receiving member 113, a spindle 131 disposed within the main body 110, a cord wrapping wheel 130 rotatably disposed on the spindle 131 and configured to attach to a second end of the cord 120 such that a portion of the cord 120 disposed within the main body 110 is wrapped around the cord wrapping wheel 130, and such that the cord wrapping wheel 130 is rotatable in a first direction to allow portions of the cord 120 to be extracted from the main body 110 through the cord aperture 112, and such that the cord wrapping wheel 130 is rotatable in a second direction to allow portions of the cord 120 to enter the main body 110 through the cord aperture 112 and wrap around the cord wrapping wheel 130, and a motor 140 disposed within the main body 110 and coupled to the cord wrapping wheel 130 such that the motor 140 is configured to cause the cord wrapping wheel 130 to selectively rotate in a first direction or a second direction in response to the motor 140 being activated, such that the rotation of the motor 140 is transferred to the cord wrapping wheel 130 to cause the cord wrapping wheel 130 to rotate in the first direction or the second direction.

The body stretching assistant 100 may further include a motor control unit 160 electrically connected to the motor 140 to control the rotational direction of the motor 140, the motor control unit 160 including a bi-directional switch 161 disposed on the handle 111 and configured to be pressable at left side of the bi-directional switch 161 to activate the motor 140 to rotate in the first direction such that the cord wrapping wheel 130 also rotates in the first direction to extract portions of the cord 120 from the main body 110 through the cord aperture 112, and configured to be pressable at a right side of the bi-directional switch 161 to activate the motor 140 to rotate in the second direction such that the cord wrapping wheel 130 also rotates in the second direction to retract portions of the cord 120 back into the main body 110 through the cord aperture 112 such that the retracted portions of the cord 120 wrap around the cord wrapping wheel 130, and a speed regulating knob 162 turnably disposed on the handle 111 and configured to cause a speed of rotation of the motor 140 to increase in response to the speed regulating knob 162 being turned in a first direction, and configured to cause the speed of rotation of the motor 140 to decrease in response to the speed regulating knob 162 being turned in a second direction.

The body stretching assistant 100 may further include a pulley 170 to attach to an outside object or surface and configured to allow portions of the cord 120 disposed outside the main body 110 to be threaded therethrough.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A body stretching assistant, comprising:
a cord;
a main body to house at least a portion of the cord therein, the main body comprising:
a handle to protrude from a surface of the main body at a first end of the main body to allow a user to grab and hold onto the main body, and
a cord aperture disposed on the surface of the main body at a second end of the main body opposite from the first end of the main body to allow portions of the cord to be extracted from the main body through the cord aperture, and
a cord receiving member disposed on the surface of the main body and configured to allow a first end of the cord to be attached to the cord receiving member;
a spindle disposed within the main body;
a cord wrapping wheel rotatably disposed on the spindle and configured to attach to a second end of the cord such that a portion of the cord disposed within the main body is wrapped around the cord wrapping wheel, and such that the cord wrapping wheel is rotatable in a first direction to allow portions of the cord to be extracted from the main body through the cord aperture, and such that the cord wrapping wheel is rotatable in a second direction to allow portions of the cord to enter the main body through the cord aperture and wrap around the cord wrapping wheel; and
a motor disposed within the main body and coupled to the cord wrapping wheel such that the motor is configured to cause the cord wrapping wheel to selectively rotate in a first direction or a second direction in response to the motor being activated, such that the rotation of the motor is transferred to the cord wrapping wheel to cause the cord wrapping wheel to rotate in the first direction or the second direction.

2. The body stretching assistant of claim 1, further comprising:
a motor control unit electrically connected to the motor to control the rotational direction of the motor, the motor control unit comprising:
a bi-directional switch disposed on the handle and configured to be pressable at left side of the bi-directional switch to activate the motor to rotate in the first direction such that the cord wrapping wheel also rotates in the first direction to extract portions of the cord from the main body through the cord aperture, and configured to be pressable at a right side of the bi-directional switch to activate the motor to rotate in the second direction such that the cord wrapping wheel also rotates in the second direction to retract portions of the cord back into the main body through the cord aperture such that the retracted portions of the cord wrap around the cord wrapping wheel; and
a speed regulating knob turnably disposed on the handle and configured to cause a speed of rotation of the motor to increase in response to the speed regulating knob being turned in a first direction, and configured to cause the speed of rotation of the motor to decrease in response to the speed regulating knob being turned in a second direction.

3. The body stretching assistant of claim 2, further comprising:
a pulley to attach to an outside object or surface and configured to allow portions of the cord disposed outside the main body to be threaded therethrough.
